(19) United States
(12) Patent Application Publication
(10) Pub. No.: US 2012/0175890 A1
(43) Pub. Date: Jul. 12, 2012

(54) Control and method of a starter motor for a starter device

(76) Inventors: Jie Ge, Stuttgart-Hausen (DE); Achim Herzog, Backnang (DE); Falco Sengebusch, Stuttgart-Feuerbach (DE)

(21) Appl. No.: 13/382,820

(22) PCT Filed: Jul. 14, 2010
(86) PCT No.: PCT/EP2010/060157

§ 371 Date: Mar. 26, 2012

(30) Foreign Application Priority Data
Jul. 20, 2009 (DE) 102009027828.1

(51) Int. Cl. F02N 11/08

(52) U.S. Cl. 290/38 R

(57) ABSTRACT

A control is described for a starter device of an internal combustion engine in a vehicle having a starter motor, a first current path and at least one additional second current path, which is connected in parallel to the first current path, for energizing the starter motor, the first current path having an switching device, in particular a starter relay. In order to improve an energization of the starter motor, the control is in operative contact with a testing device for checking a switching state of the switching device and provided with an adapter for adapting the energization of the switching device.

### FIELD OF THE INVENTION

The present invention relates to a control for a starter device of an internal combustion engine in a vehicle having a starter motor, a first current path and at least one additional second current path, which is connected in parallel to the first current path, for energizing the starter motor, the first current path having an switching device, in particular a starter relay.

The present invention further relates to a method for operating a control, in particular of this type, for a starter device of an internal combustion engine in a vehicle having a starter motor, a first current path, which has an switching device, in particular a switching relay, and at least one additional second current path which is connected in parallel to the first current path, the starter motor being energized via the second current path, and the switching device being switched for energizing the starter motor via the first current path at a point in time t₁. Finally, the present invention relates to a computer program product for executing the steps of the method, if the program runs in the mentioned control.

### BACKGROUND INFORMATION

Conventionally, internal combustion engines of motor vehicles are started with the aid of a starter motor which is supplied via a battery of the motor vehicle. For this purpose, a high electrical power, in particular a high current, may be necessary so that the start of the internal combustion engine results in a voltage drop of a battery-operated vehicle electrical system.

The starter motor is energized via a first current path, the so-called main current path, which has an switching device, in particular a starter relay operating as a switching relay, in order to supply a high electrical power to the starter motor.

Furthermore, start-stop systems for saving fuel or for reducing CO₂ emissions are available, the internal combustion engines being switched off via a control during a short-term stopping phase of the motor vehicle, at a traffic light or due to an obstruction to traffic, for example, and being started when the motor vehicle continues driving. In the case of such a start, namely a warm start following the stopping phase, electrical consumers, e.g., a vehicle electronic system, a navigation system or an audio system, are in operation and respond sensitively to a new voltage drop of the vehicle electrical system.

In order to reduce the voltage drop, the starter motor may be cranked via at least one additional second current path, which is connected in parallel to the main current path, with the aid of a reduced operating current, to subsequently energize the starter motor via the main current path with full power. Thus, a starting current, i.e., the voltage drop of the vehicle electrical system, is also reduced.

German Patent Application No. DE 10 2005 021 227 A1 describes a starter device having a redundant energization of a starter motor, namely via one current path having a starter relay, and via a second, parallel-connected current path.

It is an object of the present invention to refine a control and a method of the above-mentioned type in such a way that the starter motor may be energized more reliably via two current paths.

### SUMMARY

In accordance with the present invention, a control is designed to be in operative contact with a testing device for checking a switching state of an switching device, and to have an adapter for adapting the energization of the switching device. The switching device is checked for proper function with the aid of the testing device. The energization of the starter motor is thus reliably improved. The adapter accordingly responds to a result of the mentioned test by varying the energization of the switching device. Preferably, a switching module functioning as an adapter, which has at least one additional parallel current path for controlling current, is adapted to the actual switching state of the switching device. Thus, an increase in the energization stability of the starter motor may be achieved overall with the aid of reliable switching states.

The testing device and/or also the adapter may be designed as an integral part of the control, as a circuit system in a structural unit, for example. Alternatively, the testing device and/or the adapter may be designed to be structurally separate from the control, the testing device and/or the adapter then being in operative contact with the control, preferably via a data bus, a signal line or a control line.

The first current path, hereinafter also referred to as main current path, preferably has a starter relay as the switching device, namely for energizing the starter motor with full power for starting an internal combustion engine of the motor vehicle, the switching device being switched, i.e., being activated to be switched, at a point in time t₁. During this process, in particular, the switching state of the switching device may not change until point in time t₁, in particular following a certain, characteristic switching delay or switching duration which is determined by the configuration of the switching device, for example.

In addition to the main current path, at least one additional second current path, which is connected in parallel to the first current path, is used to additionally energize the starter motor, namely preferably for a lower energization as compared to the main current path in order to facilitate the meshing of a starter pinion of the starter motor into an annular gear of the internal combustion engine by allowing the starter motor to rotate gently at low power, or also, as mentioned above, to delimit a starting current.

It is preferred that at least one of the additional current paths, which are connected in parallel to the main current path, passes through the adapter, i.e., is also in particular implementable as a current path of the switching module.

Subsequently, the at least one additional parallel-connected current path is referred to as auxiliary current path. In this case, the auxiliary current path may include both only a single and a plurality of parallel-connected current paths.

A specific embodiment having exactly three current paths, which are connected in parallel to the first current path, is preferred as an auxiliary current path so that the starter motor may be energized with the aid of different combinations of current paths, in particular also via different currents, in particular starting currents.

Preferably, the switching state of the switching device is checked at a point in time t₃ chronologically after point in time t₁, in particular following a characteristic switching duration or switching delay of the switching device. Such a time delay allows a response time of the switching device to be taken into account, and the reliability during the test to be increased. For this purpose, point in time t₃ is variably adjustable in the control. Alternatively, the switching state is continuously checked starting from point in time t₁. If the intended switching state does not occur within a certain time period, this is detected and the control responds accordingly.

In a preferred specific embodiment, the auxiliary current path is energized for cranking the starter motor, in particular starting from a point in time t₀ before point in time t₁. For cranking, the starter motor may be energized with a reduced current intensity compared to the current feed of the main current path, in order to reduce a voltage drop of the vehicle electrical system. Furthermore, a low cranking current is generated, in order to prevent a tooth-on-tooth position during the meshing of the starter pinion into the annular gear.

Furthermore, the energization of the starter motor via the auxiliary current path is continued, preferably at least until point in time t₃ of the switching device test, in order to not interrupt the energization of the starter motor in the case of a switching delay of the switching device, for example.

It is thus particularly preferred that the auxiliary current path is energized for cranking the starter motor starting from a point in time t₀ before point in time t₁ until at least point in time t₃ of the switching device test.

During a starting request for starting the internal combustion engine, by operating an ignition switch, for example, the control may thus execute the following steps, namely energizing the starter motor via the auxiliary current path starting from point in time t₀ in order to crank the starter motor, while delimiting a cranking current and reducing a voltage drop. After a certain period of time, in particular when the starter motor has been sufficiently cranked, at point in time t₁ the switching device may be switched, i.e., activated for switching, in order to energize the starter motor via the main current path with full power. Finally, in particular after or during a characteristic switching duration, the switching device may be checked at or until a point in time t₃ in order to verify a switching operation of the switching device.

It is preferred that the current feed of the auxiliary current path is reduced, if during an energized setpoint state of the switching device, the test yields a de-energized switching state as the actual state. In such a case, the switching device has not switched reliably, which may be attributed, in particular, to a voltage drop in the vehicle electrical system of the motor vehicle, which reduces the reliability of the switching device during switching. This voltage drop may be reduced by reducing the current feed of the auxiliary current path and thus increasing the switching device stability. In particular, in the case of a starter relay as the switching device, the relay coil current necessary for reliable switching is no longer achieved during a voltage drop. By reducing the current of the auxiliary current path, the voltage, i.e., the coil current as well, of the starter relay and the stability during switching may be increased.

In order to energize the starter motor via the auxiliary current path, which is reduced compared to the current feed via the main current path, the auxiliary current path preferably has a resistor element of the adapter, in particular of the switching module. The current feed of the auxiliary current path is thus adjustable in a defined manner, in a plurality of parallel-switched current paths of the auxiliary current path, every single current path preferably having such a resistor element.

The resistor elements may have identical or also differing resistances so that the current intensity, output overall to the starter motor as a result of the energization of the different, parallel current paths, may be adjusted both with the aid of a different quantity and a different selection of the parallel current paths to be energized.

Furthermore, it is preferred that the auxiliary current path has a switch of the adapter, in particular of the switching module, using which the current feed of the auxiliary path may be switched on and off. In particular, the switch may be designed as an electronic power switch, e.g., a power FET.

In addition to that, in a plurality of parallel current paths of the auxiliary current path, only some of the current paths may each have a switch; however, every one of these current paths is preferably provided with such a switch. In this way, any current path combinations may be energized, in order to, for example, control the current intensity, in particular a cranking current, when energizing the starter motor.

Furthermore, the current feed may also be switched off completely when adapting the current feed of the auxiliary current path according to the present invention. The current feed may thus be easily adapted, i.e., by simply switching the switches, and, in addition, the control, in particular the adapter, may be implemented cost-effectively, i.e., having simple switches.

In one preferred specific embodiment, the testing device is designed for the purpose of checking the switching state of the switching device with the aid of a current measurement of the energization of the starter motor. Since the switching device switches the current feed of the main current path on and off, the switching state of the switching device may be checked easily and reliably based on the current intensity, in particular of the main current path.

An object is further achieved with the aid of a computer program product which is loadable in a program memory with program instructions in order to execute the steps of one of the methods mentioned previously or in the following, when the program runs in a control according to the present invention. The computer program has the advantage that individually and/or empirically ascertained values for switching and executing the computer program are easily variable and adaptable.

It is understood that the above-mentioned features and the features to be explained below are usable not only in the indicated combination, but also in other combinations.

### BRIEF DESCRIPTION OF THE DRAWINGS

The present invention is explained below in greater detail with reference to the figures.

FIG. 1 shows a schematic circuit diagram of a control according to an example embodiment of the present invention for a starter device.

FIG. 2 shows a schematic operating diagram of a method according to the present invention for operating the control according to FIG. 1.

FIG. 3 shows a diagram of a time curve of a vehicle electrical system voltage and an energization of an switching device.

### DETAILED DESCRIPTION OF EXAMPLE EMBODIMENTS

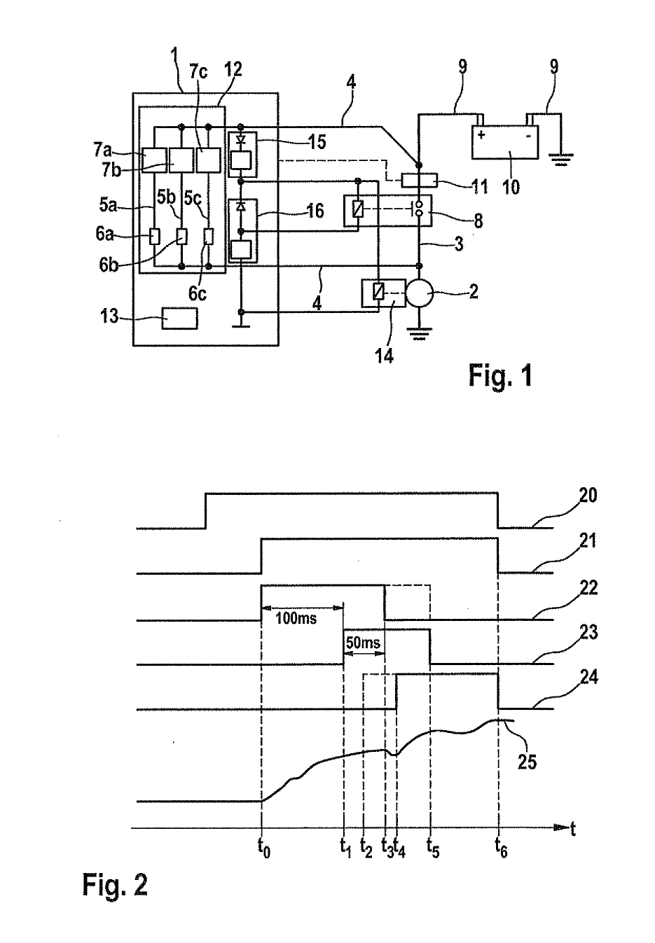

FIG. 1 shows a schematic circuit diagram of a control 1 for a starter device having a starter motor 2, a first current path, the so-called main current path 3, and an additional second current path, i.e., auxiliary current path 4, which is connected in parallel to main current path 3. Main and auxiliary current paths 3, 4 are each supplied from a battery 10 via a vehicle electrical system 9 and are designed for a redundant energization of starter motor 2.

Main current path 3 has an switching device 8 which is an integral part of a starter relay, which in addition includes a meshing device 14 having a relay coil for meshing a starter pinion (not shown) of starter motor 2 into an annular gear of an internal combustion engine (also not shown). Switching device 8 and meshing device 14 are thus implemented together in the starter relay, each having a coil winding, and are only shown separately in FIG. 1 to provide a better overview.

Auxiliary current path 4 passes through control 1 and, in particular, also through an adapter 12 which is implemented as a switching module in one structural unit with control 1, auxiliary current path 4 including three parallel-connected current paths 5a, 5b, 5c within adapter 12 for energizing starter motor 2. Each of these parallel-connected current paths 5a, 5b, 5c is implemented to have an electronic power switch 7a, 7b, 7c, i.e., a power FET, and a resistor element 6a, 6b, 6c for delimiting the current of the particular current path 5a, 5b, 5c. With the aid of power switches 7a, 7b, 7c, the energization of starter motor 2 via auxiliary current path 4 may be switched on and off, and, moreover, the current intensity of the current feed may be varied between up to seven stages, by switching on only one power switch 7a, 7b, 7c, exactly two, or all three power switches. In this way, the current feed of auxiliary current path 4 may be easily adapted, in particular also reduced or switched off completely.

In addition to main and auxiliary current paths 3, 4, battery 10 also energizes switching device 8 and meshing device 14, each switchable independently from one another via switches 15, 16 having diodes, via vehicle electrical system 9, namely to switch switching device 8 into an energized state or to couple starter motor 2 with the internal combustion engine with the aid of meshing device 14.

Furthermore, control 1 is designed to be in operative contact with a testing device 11 for checking a switching state of switching device 8, testing device 11 being designed to check the switching state of switching device 8 with the aid of a current measurement of the energization of starter motor 2 via main current path 3. In this case, testing device 11 is preferably situated on the starter device.

Moreover, a microcomputer 13 having a program memory is an integral part of control 1, in particular for the purpose of switching power switches 7 a, 7 b, 7 c and switches 15, 16 having diodes. In microcomputer 13, a computer program product is run, which is loaded in the program memory (not shown) with program instructions, in order to execute a method according to the present invention, in particular the steps described in FIG. 2, for operating control 1.

FIG. 2 shows an example schematic operating diagram of a method for operating control 1 shown in FIG. 1; the events and states elucidated below are shown located vertically above one another along a time axis t to provide a better overview. Switching characteristic curves 20-24 and a rotational speed characteristic curve 25 are plotted above time axis t.

Points in time t₀ and t₆ mark a beginning and an end of a starting process of the internal combustion engine with the aid of starter motor 2; it has to be noted that time axis t is not linear so that identical distances along time axis t do not necessarily describe an identical period of time.

In this exemplary embodiment, meshing device 14, as meshing signal 20 shows, is energized with the aid of switch 15 having a diode, even before the beginning of the starting process, i.e., before point in time t₀, in order to couple starter motor 2, as previously described, with the internal combustion engine. In this way, in the case of a starting request 21 which is triggered by a starter button or also a start-stop control, for example, cranking of starter motor 2 may begin virtually without delay in order to start the internal combustion engine as quickly as possible.

Simultaneously with starting request 21, starter motor 2 is cranked in an additional method step. For this purpose, it is energized only via auxiliary current path 4 for the time being, by switching on an appropriate selection of power switches 7a, 7b, 7c according to a power switch signal 22 in the switching module, in order to feed corresponding parallel-connected current paths 5a, 5b, 5c with current having a current intensity which is delimited and defined by resistors 6a, 6b, 6c.

In order to control the current intensity, i.e., in particular a cranking current of starter motor 2, a particular selection of power switches 7a, 7b, 7c to be switched is determined according to a method, which is not explained here in greater detail, in accordance with a charging state of battery 10, an influence of temperature and aging effects and/or also of the particular dimensioning of vehicle electrical system 9, in particular of internal line resistances.

When cranking starter motor 2 with the aid of an energization which is delimited by resistors 6a, 6b, 6c, a voltage drop of vehicle electrical system 9 is reduced so that additional (not shown) electrical consumers are influenced to a lesser extent, when the internal combustion engine is started.

After a certain cranking period, e.g., approximately 100 ms, a rotational speed, shown as rotational speed characteristic curve 25, of starter motor 2 has increased to such an extent that an energization is switched on according to switching characteristic curve 23 of switching device 8 at point in time t₁ in order to feed main current path 3 with current with the aid of switching device 8, namely to operate starter motor 2 with full power. Due to the previous cranking, namely from point in time t₀ until point in time t₁, the voltage drop in vehicle electrical system 9 may be reduced by not switching to the full power, in particular the maximum current via main current path 3, until starter motor 2 is already rotating.

Switching device 8 has a certain switching delay so that a change in the switching state according to switching characteristic curve 24 of switching device 8 normally takes place at a point in time t₂ with a delay of approximately 20 ms to 30 ms, for example, usually, however, within 50 ms, following the beginning of the energization according to characteristic curve 23 of switching device 8 at point in time t₁. By energizing starter motor 2 via auxiliary current path 4, a voltage drop of vehicle electrical system 9, which is reduced due to the current delimitation with the aid of resistors 6a, 6b, 6c, but is still noticeable, so that in the case of a weak vehicle electrical system 9, a partially run-down battery 10 and/or also a hot starter relay, the current intensity arising in the process of energizing switching device 8 is no longer sufficient for reliable switching, in particular for closing a contact, for energizing starter motor 2 via main current path 3.

As a result, at point in time t₃, i.e., after the normal switching delay, the switching state is checked according to characteristic curve 24 of switching device 8 by control 1 with the aid of testing device 11, namely by measuring the energization of starter motor 2 via main current path 3. If switching device 8 fails to achieve an energized switching state at point in time t₃, power switches 7a, 7b, 7c are switched off not at a later point in time t₅ according to power switch signal 22 but already at point in time t₃. Therefore, the energization of starter motor 2 via auxiliary current path 4 is interrupted and a voltage rise of vehicle electrical system 9 is achieved.

With the increasing voltage of vehicle electrical system 9, the current intensity of the energization also increases according to characteristic curve 23 of switching device 8, i.e., of its coil winding, so that, after a short period of time, the switching device switches reliably and an energized switching state according to characteristic curve 24 at point in time t₄ is achieved. Starting from point in time t₄, the internal combustion engine is thus driven with the full power of starter motor 2 and started in this way.

Starting from point in time t₅, the rotational speed has reached a measure according to characteristic curve 25, starting from which the internal combustion engine may run automatically and the starting process may be concluded. For this purpose, the energization according to characteristic curve 23 of switching device 8 is discontinued. With a certain delay at point in time t₆, switching device 8 subsequently assumes once again a switched-off switching state according to characteristic curve 24 so that the energization of starter motor 2 via main current path 3 is also discontinued. As mentioned previously, the starting process is thus completed at point in time t₆.

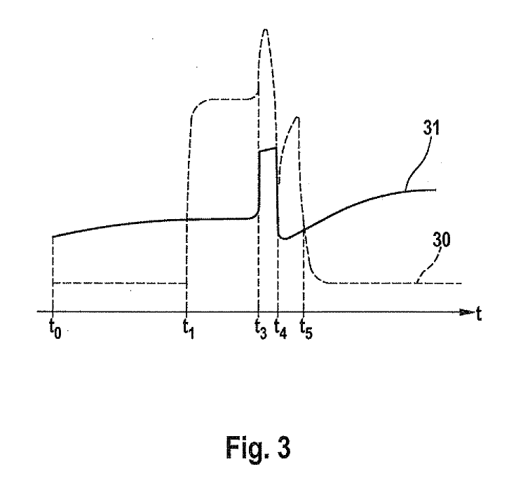

FIG. 3 shows an energization according to characteristic curve 23 of switching device 8 and a vehicle electrical system voltage 31 of vehicle electrical system 9. For this purpose, current intensity 30 of the energization of switching device 8 and vehicle electrical system voltage 31 are plotted above time axis t, current intensity 30 representing a coil current of switching device 8 designed as a relay.

As explained previously, at point in time t₀, power switches 7a, 7b, 7c are switched on and starter motor 2 is cranked, vehicle electrical system voltage 31 of approximately 12 V to 14 V in the no-load state dropping to a value between 7 V and 8 V or below due to the resulting current flow, namely via auxiliary current path 4.

At point in time t₁, switching device 8 is energized so that current intensity 30 rapidly rises from 0 A to a value between 9 A and 10 A. Due to low vehicle electrical system voltage 31, resulting current intensity 30 does not suffice, however, to successfully switch switching device 8, i.e., to change the switching state to an energized state according to characteristic curve 24 so that, based on the check at point in time t₃, auxiliary current path 4 is switched off with the aid of power switches 7a, 7b, 7c, and vehicle electrical system voltage 31 consequently rises.

With increasing vehicle electrical system voltage 31, current intensity 30 of the energization of switching device 8 also increases for a reliable switching so that switching device 8 assumes the intended energized switching state according to characteristic curve 24 at point in time t₄. As a result, starter motor 2 is energized via main current path 3 with full power resulting in an additional drop in vehicle electrical system voltage 31. Finally, at point in time t₅, the energization according to characteristic curve 23 of switching device 8 is discontinued.

Overall, this example method may thus improve the stability of switching device 8 with respect to a poor condition of the vehicle electrical system or an increased temperature. Furthermore, with the aid of the example method according to the present invention, switching device 8 may switch reliably under any conditions, even in different vehicle platforms in which differing voltage drops may also occur, in particular. Apart from that, in particular aging effects or changes in resistors within one electric circuit for activating switching device 8 may be tolerated to a greater extent. All figures show only schematic, not true to scale illustrations.

1-7. (canceled)

8. A control for a starter device of an internal combustion engine in a vehicle, having a starter motor, a first current path and at least one additional second current path which is connected in parallel to the first current path, for energizing the starter motor, the first current path having a switching device, the control being in operative contact with a testing device for checking a switching state of the switching device, the control comprising:
an adapter to adapt energization of the switching device; and
an electric power switch;
wherein at least one of the additional second current paths has a resistor element of the adapter, and at least one of the additional second current paths has the electronic power switch with the aid of which a current feed of the at least one of the second current paths may be switched on and off.

9. The control as recited in claim 8, wherein the testing device is to check the switching state of the switching device by measuring current of the energization of the starter motor.

10. A method for operating a control for a starter device having a starter motor, a first current path which has a switching device and at least one additional second current path which is connected in parallel to the first current path, the starter motor being energized via the second current path and the starter device being switched for energizing the starter motor via the first current path at a point in time t₁, the method comprising:
checking a switching state of the switching device at a point in time t₃, chronologically after the point in time t₁ after a switching duration of the switching device; and
adapting an energization of the switching device to the switching state.

11. A method for operating a control for a starter device having a starter motor, a first current path, which has an switching device, and at least one additional second current path which is connected in parallel to the first current path, the starter motor being energized via the second current path, the method comprising:
switching the switching device for energizing the starter motor via the first current path at a point in time t₁;
checking a switching state of the switching device at a point in time t₃ chronologically after the point in time t₁;
adapting the energizing of the switching device to the switching state; and
energizing at least one of the additional parallel-connected current paths for cranking the starter motor from a point in time t₀ before the point in time t₁ until at least the point in time t₃.

12. The method as recited in claim 11, wherein the energization of the switching device is adapted by reducing a current feed of at least one of the additional parallel-connected current paths if, during an energized setpoint state of the switching device, the checking yields a de-energized switching state.

13. The method as recited in claim 12, wherein, for the adapting, a current feed of all of the additional second current paths which are connected in parallel are switched off individually via a switch of the particular second current path.

14. A storage device storing a computer program for operating a control for a starter device having a starter motor, a first current path which has a switching device, and at least one additional second current path connected in parallel to the first current path, the starter motor being energized via the second current path and the starter device being switched for energizing the starter motor via the first current path at a point in time t₁, the computer program, when executed by a controller, causing the controller to perform the steps of:
checking a switching state of the switching device at a point in time t₃, chronologically after the point in time t₁ after a switching duration of the switching device; and
adapting an energization of the switching device to the switching state.
